(19) United States
(12) Patent Application Publication
(10) Pub. No.: US 2025/0158541 A1
(43) Pub. Date: May 15, 2025

(54) ADAPTIVE ENERGY HARVESTING FOR IMPROVED USER EXPERIENCE

(71) Applicant: ASSA ABLOY AB, Stockholm (SE)

(72) Inventor: Bernt Arbegard, Altura (PT)

(21) Appl. No.: 18/832,625

(22) PCT Filed: Feb. 16, 2023
(86) PCT No.: PCT/EP2023/053953

§ 371 Date: Jul. 24, 2024

(30) Foreign Application Priority Data
Feb. 22, 2022 (SE) 2250234-8

(51) Int. Cl. H02N 11/00; E05B 47/00; H02J 7/00; H02M 3/158

(52) U.S. Cl. CPC H02N 11/002; H02M 3/158; E05B 47/0001; E05B 2047/0058; E05B 2047/0062; H02J 7/0063; H02J 7/0068

(57) ABSTRACT

An energy harvesting system is provided, including an energy storage element, a generator assembly configured to convert an actuation force (F) provided by a user into an electrical power, and a power converter assembly configured to transfer the electrical power from the generator assembly to the energy storage element. The power converter assembly is further configured to adapt its input impedance (Z1(F)) to a magnitude of the actuation force by decreasing its input impedance when the magnitude of the actuation force increases, and by increasing its input impedance when the magnitude of the actuation force decreases. A corresponding power converter assembly and an electronic lock including the energy harvesting system are also provided.

### TECHNICAL FIELD

The present disclosure relates to the field of energy harvesting. In particular, the present disclosure relates to improvement of such energy harvesting in combination with electronic locking systems.

### BACKGROUND

In order to operate as intended, electronic locking systems need a reliable power supply. Electrical power may for example be required to drive one or more lock bolts, to enable e.g. wireless communication with a user key, and/or to drive various other electronics required to operate the lock.

If access to a power grid is not readily available, electronic locking systems may instead be powered using for example one or more batteries. However, in order to not repeatedly having to replace such batteries as they discharge, it has been proposed to utilize the concept of energy harvesting to instead recharge such batteries. By connecting e.g. a door handle to a generator, the mechanical power provided by a user (when operating the door handle) can be converted into electrical energy and stored in an energy storage element (such as e.g. a capacitor, supercapacitor, battery, or similar). When needed, electrical energy can then be withdrawn from the energy storage element and provided to the electronic locking system.

In order to optimize the efficiency of an energy harvesting system as described above, an optimal operating point of the generator is often decided by utilizing the concept of an “average user”. It is assumed that the strength of the average user is such that a same average amount of mechanical power will always be provided, and the optimal operating point of the generator is tailored accordingly. In real-life situations, however, the available strength and resulting power will vary between different users. A weaker than average user may for example find the effort needed to operate the lock to be too high, while a stronger than average user may find the same effort to be too small. Such behavior of the energy harvesting system may thus lead to a user experience which varies greatly from user to user, and in particular to a user experience which is less than optimal for users whose strength is not that of the assumed average user.

### SUMMARY

To at least partially solve the above identified problem with varying user experience when using electronic locking systems together with energy harvesting, the present disclosure provides an improved energy harvesting system, an improved power converter assembly, and an improved electronic lock which adapt to the strength of the user and as defined in the independent claims. Various alternative embodiments of the energy harvesting system, the power converter assembly and the electronic lock are defined in the dependent claims.

According to a first aspect, an energy harvesting system is provided. The system includes an energy storage element. The system further includes a generator assembly configured to convert an actuation force provided by a user into electrical power. The system also includes a power converter assembly configured to transfer the electrical power from the generator assembly to the energy storage element. The power converter assembly is further configured to adapt its input impedance to a magnitude of the actuation force. This adaptation is performed by the power converter assembly decreasing its input impedance when a magnitude of the actuation force increases, and by the power converter assembly increasing its input impedance when the magnitude of the actuation force decreases.

By adapting the input impedance of the power converter assembly to the magnitude of the actuation force of the user, the present disclosure improves upon currently available technology in that the loading of the generator assembly provided by the power converter assembly may thus be increased for a stronger user, and reduced for a weaker user. An increased loading of the generator would thus require the stronger user to apply a larger torque in order to turn e.g. a doorknob at a constant speed, but would also thus allow the stronger user to charge the energy storage element more quickly (as the number of turns needed before the energy storage element is sufficiently charged would be reduced). For the weaker user, on the other hand, the torque required to turn the doorknob at the same constant speed would be less, but the weaker user would instead need to turn the doorknob more turns before the energy storage element is fully charged. Importantly, however, is that although the weaker user may have to operate the doorknob for a longer time, the required torque needed to turn the doorknob can be tailored such that it does not exceed a capability of the weaker user. The dynamical range of the energy harvesting system (and of an electronic locking system in which the energy harvesting system is used) is thus increased, and the overall user experience is improved for users having different strengths different than those of the assumed average user.

Herein, the “electrical power” is preferably a direct current (DC) electrical power. It is envisaged that the generator assembly may for example include a generator which is configured to output an alternating current (AC) electrical power, and that in such a case there is also provided (either as part of e.g. the generator assembly or as part of the power converter assembly) any circuitry required for first converting such AC electrical power to DC electrical power.

In some embodiments, the power converter assembly may be of a switched-mode type. The power converter assembly may include an inductor, and the inductor may be switched to alternately i) store energy received from the generator assembly and ii) release the stored energy to the energy storage element. The storing of energy may occur during a first part of a full switching period, and the releasing of energy may occur during a second part of the full switching period. The input impedance of the power converter may depend on a switching of the inductor. The switching (of the inductor) may be performed based on a first voltage across a resistor circuit which is connected in series with the inductor during at least one of the first and second parts of the full switching period. The resistor circuit may be configured to help cause the adaptation of the input impedance of the power converter assembly to the magnitude of the actuation force, by the resistor circuit decreasing its resistance when the magnitude of the actuation force increases, and by increasing its resistance when the magnitude of the actuation force decreases.

In some embodiments, the magnitude of the actuation force may be provided as a second voltage. The second voltage may be proportional to an output voltage of the generator assembly. The second voltage may be provided e.g. to the resistor circuit, and the resistor circuit may use the second voltage as an indication of the magnitude of the actuation force.

In some embodiments, the energy harvesting system may further include a voltage divider circuit for providing the second voltage. The proportionality of the second voltage to the output voltage of the generator assembly may be governed by the relative values of the resistances of the voltage divider circuit. The voltage divider circuit may e.g. in one end be connected to an output terminal of the generator assembly (or to an input terminal of the power converter assembly) and in another end to e.g. a ground or other potential, and the second voltage may be provided at a node between the resistances of the voltage divider circuit.

In some embodiments, the energy harvesting system may further include a first microprocessor-based circuit. The first microprocessor-based circuit may be configured to obtain the output voltage of the generator assembly and to provide the second voltage proportional to the output voltage of the generator assembly, e.g. by performing one or more calculations.

In some embodiments, the resistor circuit may include a first branch and a second branch. The first and second branches may be connected in parallel. The first branch may include a first resistor, and the second branch may include a second resistor and a (first) switching element connected in series. To help cause the adaptation of the resistance of the resistor circuit, the switching element of the second branch may be configured to be controlled based on the second voltage. For example, the switching element may be a voltage-controlled switch, such as e.g. a MOSFET, and the second voltage may be applied to (or at least used to generate a voltage applied to) a gate terminal of the voltage-controlled switch. Phrased differently, at one extreme, the resistance of the resistor circuit may be that of the first resistor only. At another extreme, the resistance of the resistor circuit may be that of the first and second resistors connected in parallel. By regulating the current through the second branch, the switching element may allow the resistance of the resistor circuit to take a value at or in between these two extremes, based on the magnitude of the actuation force (e.g. based on the second voltage). As the resistance of two resistors in parallel is always smaller than the resistance of any of the two resistors individually, the resistance of the resistor circuit may thus be made to decrease when the magnitude of the actuation force increases (and to increase when the magnitude of the actuation force decreases, where the increase and decrease are with respect to e.g. a working point wherein at least some current is allowed to pass through the second branch). The use of the switching element allows the transition between having only the first branch contributing to the resistance of the resistor circuit to including also (at least part of) that of the second branch to be smooth, which may provide an improved user experience.

In some embodiments, the resistor circuit may further include a third branch connected in parallel with the first branch and the second branch. The third branch may include a third resistor and a second switching element connected in series. Just as for the second branch, the second switching element may be configured to be controlled based on a (third) voltage proportional to the output voltage of the generator assembly. This third voltage may for example have a different proportionality factor/constant than that of the second voltage. This may help causing the adaptation of the resistance of the resistor circuit by regulating also a current through the third branch based on the magnitude of the actuation force. There may also be one or more additional such further branches (such as a fourth branch, a fifth branch, etc.) connected in parallel with the first, second and third branches. Using more than two parallel branches can provide a load function having multiple steps, e.g. by the switching elements being configured to regulate the current in their respective branches based on different fractions of the magnitude of the actuation force. For example, the second branch may start to be gradually inserted in parallel with the first branch once the magnitude of the actuation force reaches a first threshold value, while the third branch may start to be gradually inserted in parallel with the first and second branches once the magnitude of the actuation force reaches a second threshold value higher than the first threshold value, etc. Using multiple further branches may e.g. help to account for a wider span of user strengths, helping to even further increase the user experience for a wider range of users. Here, being “gradually inserted” means that that the inclusion of a particular branch starts having a notable effect on the overall resistance of the resistor circuit.

In some embodiments, the resistor circuit may include a digital potentiometer and a second microprocessor-based circuit. The second microprocessor-based circuit may be configured to obtain the magnitude of the actuation force (e.g. by measuring the second voltage), and based thereon control the digital potentiometer. For example, the digital potentiometer may be controlled such that the resistance of the resistor circuit increases when the magnitude of the actuation force decreases, and vice versa, helping to provide the envisaged adaptation of the input impedance of the power converter assembly to the magnitude of the actuation force as described earlier herein. The use of the digital potentiometer may e.g. provide an alternative solution to that of using the two or more parallel branches described above. Using the two or more parallel branches may however be convenient in that no external powering (of e.g. a microprocessor or similar) is required.

According to a second aspect of the present disclosure, a power converter assembly is provided. The power converter assembly may for example be used for the energy harvesting system as described above, but also for other situations as will be described herein. The power converter assembly includes an input terminal for receiving an input voltage (e.g. an output voltage from the generator assembly), and an output terminal for providing an output voltage (e.g. to an energy storage element as also discussed herein). The power converter assembly is configured to transfer an electrical power from the input terminal to the output terminal (e.g. from the generator assembly to the energy storage element). The power converter assembly is further configured to adapt its input impedance to the input voltage at the input terminal by decreasing its input impedance when a magnitude of the input voltage increases, and by increasing its input impedance when the magnitude of the input voltage decreases. Any benefits, specifics and/or alternative embodiments discussed herein and related to the power converter assembly in the energy harvesting system of the first aspect apply also to the power converter assembly of the second aspect.

In some embodiments of the converter assembly, the converter assembly may be of a switched-mode type and include an inductor, a switching element for switching the inductor to alternately i) store energy received at the input terminal during a first part of a full switching period and ii) release the stored energy at the output terminal during a second part of the full switching period, and a resistor circuit connected in series with the inductor during at least one of the first and second parts of the full switching period. The switching of the inductor may be performed based on a first voltage across the resistor circuit. The resistor circuit may further be configured to decrease its resistance when a magnitude of the input voltage increases, and to increase its resistance when the magnitude of the input voltage decreases.

In some embodiments of the converter assembly, the resistor circuit may include a first branch and a second branch connected in parallel. The first branch may include a first resistor, and the second branch may include a second resistor and a switching element connected in series. The switching element may be configured to be controlled based on a second voltage proportional to the input voltage. As described herein, the switching element may in some embodiments be e.g. a voltage-controlled transistor, such as a MOSFET or similar.

In some embodiments of the converter assembly, the resistor circuit may further include a third branch connected in parallel with the first and second branches. The third branch may include a third resistor and a second switching-element connected in series. The second switching-element may be configured to be controlled based on a third voltage proportional to the input voltage. As described herein, the third voltage may be different than the second voltage, e.g. by having a different proportionality constant.

In some embodiments of the converter assembly, the converter assembly may include a voltage divider circuit for providing the second voltage proportional to the input voltage.

In some embodiments of the converter assembly, the resistor circuit may include a digital potentiometer and a microprocessor-based circuit. The microprocessor-based circuit may be configured to obtain the input voltage and based thereon control the resistance of the resistor circuit using the digital potentiometer.

According to a third aspect of the present disclosure, an electronic lock is provided. The electronic lock includes a handling element (such as e.g. a lever handle, a doorknob, a thumb-turn, or any other object with which the user normally mechanically interacts when attempting to open the lock). The electronic lock further includes an electronic lock controller, and an energy harvesting system as envisaged herein (e.g. the energy harvesting system of the first aspect, or any embodiments thereof). The handling element is mechanically connected to the generator assembly (of the energy harvesting system) such that the actuation force results from a force applied to the handling element by the user (when attempting to e.g. open the lock). The energy storage element of the energy harvesting system is configured to power the electronic lock controller (i.e. there is an electrical connection formed between the energy storage element and the electronic lock controller, such that electrical energy stored in the energy storage element can be transferred to and used by the electronic lock controller).

Other objects and advantages of the present disclosure will be apparent from the following detailed description, the drawings and the claims. Within the scope of the present disclosure, it is envisaged that all features and advantages described with reference to e.g. the energy harvesting system of the first aspect are relevant for, apply to, and may be used in combination with also the power converter assembly of the second aspect and/or the electronic lock of the third aspect, and vice versa.

### BRIEF DESCRIPTION OF THE DRAWINGS

Exemplifying embodiments will be described below with reference to the accompanying drawings, in which:

FIG. 1 schematically illustrates a door including an electronic locking system and an energy harvesting system;

FIGS. 2A and 2B schematically illustrate a traditional converter assembly and energy harvesting system;

FIGS. 3A and 3B schematically illustrate various embodiments of a converter assembly and energy harvesting system according to the present disclosure;

FIGS. 3C, 3D and 3E schematically illustrate various embodiments of a resistor circuit according to the present disclosure;

FIG. 4 schematically illustrate a performance of a converter assembly and energy harvesting system according to the present disclosure compared to traditional alternatives, and

FIGS. 5A and 5B schematically illustrates an embodiment of a converter formed according to the present disclosure by modifying a converter previously disclosed by the applicant.

In the drawings, like reference numerals will be used for like elements unless stated otherwise. Unless explicitly stated to the contrary, the drawings show only such elements that are necessary to illustrate the example embodiments, while other elements, in the interest of clarity, may be omitted or merely suggested. As illustrated in the Figures, the sizes (absolute or relative) of elements and regions may be exaggerated or understated vis-à-vis their true values for illustrative purposes and, thus, are provided to illustrate the general structures of the embodiments.

### DETAILED DESCRIPTION

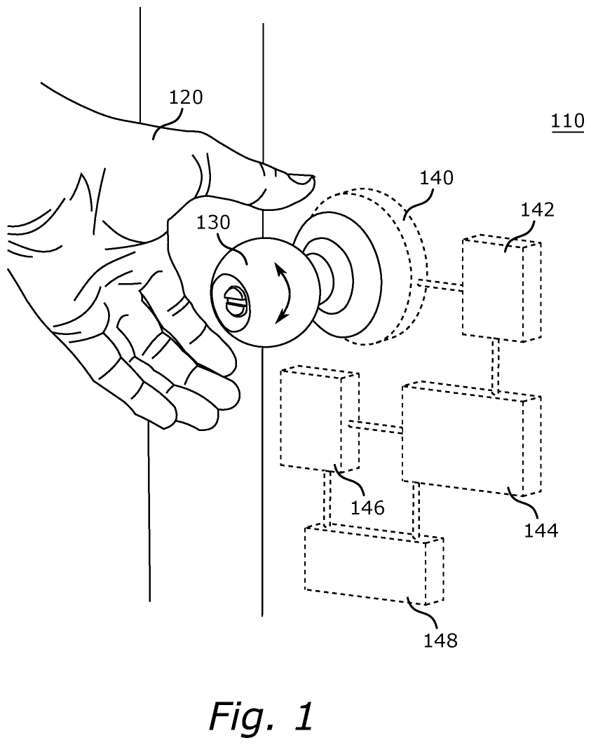

An example environment in which the present disclosure is applicable will now first be described in more detail with reference to FIG. 1.

FIG. 1 schematically illustrates a door 110 which has an electronic locking system, wherein the electronic locking system is powered by an energy harvesting system. To open the door 110, a user 120 uses e.g. a hand to turn a door handle or handling element 130. The door handle/handling element 130 may for example (as shown in FIG. 1) be a doorknob, but may also (as envisaged herein) be e.g. a lever handle, a thumb-turn, a slider, or any similar handling element/object upon which the user 120 may apply an actuation force in order to open the door 110, or at least to input mechanical power into an energy harvesting system of the door 110.

By grabbing and twisting/rotating the doorknob 130, the user 120 applies an actuation force to the doorknob 130. The doorknob 130 is mechanically connected to a generator 140 located inside the door 110, such that a resulting torque T is applied to the generator 140. An output from the generator 140 may for example be an AC voltage, and the energy harvesting system may further include a rectifier 142 in order to convert the AC voltage to a DC voltage. The output from the rectifier 142 (i.e. the resulting DC voltage) is then provided to a power converter assembly 144, which is configured to transfer electrical power from the generator 140 to an energy storage element 146. In some embodiments of the energy harvesting system, the generator 140 and rectifier 142 may be form part of a generator assembly. In other embodiments, such a rectifier 142 may instead form part of a power converter assembly 142.

One or both of the energy storage element 146 and the power converter assembly 144 are in turn electrically connected to an electronic lock controller 148, which is configured to control a locking mechanism of the door 110. The electronic lock controller 148 is thus powered by the electrical energy provided from one or both of the energy storage element 146 and the power converter assembly 144. In general, the arrangement as illustrated in FIG. 1 allows to harvest energy provided by the user when operating the doorknob 130 and to use this harvested energy to power the electronic locking system of the door 110. In other also envisaged examples, the lock may instead work in a linear fashion such that they user 120 is instead required to e.g. pull or push on a handling element/object in order to open the door 110. The actuation force applied by the user when so doing can then be converted into a torque applied to the generator 140, or the generator 140 may instead be a linear generator which does not first require any such conversion from a linear force to a torque.

The energy storage element 146 may for example be a battery, a supercapacitor, a capacitor, or any other element in which electrical energy may be stored and later withdrawn when needed. The electronic lock controller 148 may for example be configured to control a movement of one or more locking bolts (not shown), such that the door 110 may be locked and unlocked as instructed by the electronic lock controller 148. The electronic lock controller 148 may also be configured to e.g. communicate with a key fob, keycard, tag, smartphone, or other suitable device, which the user 120 may be in possession of and present to the electronic lock controller 148, in order to also verify that the user 120 attempting to open the door 110 by turning the doorknob 130 is authorized to do so. Communication between the electronic lock controller 148 and any such user-owned device may be wireless (using e.g. Bluetooth, Bluetooth Low Energy (BLE), ZigBee, NFC, RFID, one of the Wi-Fi/IEEE 802.11 standards, or any similar technology/protocol), and/or be wired and use one or more cables or other contact interfaces (using e.g. one of the Ethernet/IEEE 802.3 standards, RS485, RS232, USB, or any similar technology/protocol).

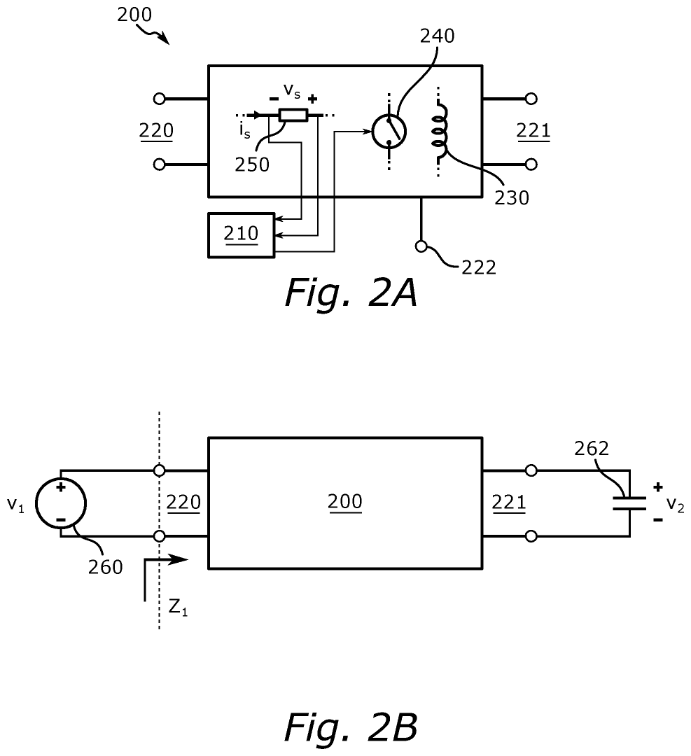

In energy harvesting systems, it is common to use a so-called DC/DC converter as part of the power converter assembly 144, and in particular a so-called switched-mode DC/DC converter (which, in comparison with its linear alternatives, often provides lower losses in terms of e.g. heat). A brief overview of such a traditional converter will now be given with reference to FIGS. 2A and 2B. In what follows, the terms “(DC/DC) power converter”, “(DC/DC) power converter assembly”, and simply “converter” will be used interchangeably.

FIG. 2A schematically illustrates a switched-mode DC/DC converter (assembly) 200. The converter 200 has one or more input terminals 220 and one or more output terminals 221. In case the converter includes only a single input terminal 220 and a single output terminal 221, there may also be a dedicated ground terminal 222. Otherwise, at least one of the input terminals 220 and/or output terminals 221 may be connected to ground if required.

The converter 200 is configured to transfer DC power from the input terminal 220 to the output terminal 221. In order to do so, the converter further includes an inductance (in form of an inductor) 230 and at least one switching element 240. The switching element 240 is configured to switch the inductor 230 such that the inductor 230 alternately i) receives and stores energy from the input terminal 220, and ii) releases the stored energy to an output terminal 221. The exact internal configuration of the converter 200 will be different depending on a desired functionality of the converter, and it is assumed herein that the skilled person is aware of many of the different switching topologies (that is, the exact configuration and interconnection of the components 230 and 240) that are already commonly available. Examples include e.g. the Buck converter (wherein the output voltage is regulated to be lower than the input voltage), the Boost converter (wherein the output voltage is regulated to be higher than the input voltage), and the Buck-boost/Flyback converter (wherein the output voltage is regulated to be either higher or lower than the input voltage). Other examples include e.g. Ćuk converters, SEPIC converters, Split-pi converters, and similar. Another example of a DC/DC power converter is a converter as disclosed by the Applicant in the international patent application PCT/EP2017/083884(the entirety of which is included herein by reference).

As envisaged herein, all such converters have in common that their method of controlling the switching of the inductor 230 relies on being able to sense a current is within the converter 200, preferably a current through the inductor 230. A common way of sensing such a current is to place a current sensing resistor 250 in a path via which the current is flows, and to use Ohm's law to infer a size of the current is based on a voltage vs measured across the resistor 250 as is =Vs/Rs (where Rs is the resistance of the resistor 250). The voltage vs is provided to (or even measured by) a control logic module 210, in which the voltage vs (and thereby the current is) is used to provide a control output for the switching element 240 such that the switching element 240 may be switched on and off as desired. Such control modes, relying on a sensed current is may be referred to as a current-control modes. Depending on exactly where the current sensing resistor 250 is located, the sensed current is may correspond to e.g. a peak-current through the inductor 230, a valley-current through the inductor 230, or e.g. an average current through the inductor 230. Phrased differently, the current sensing resistor 250 may be located such that current passes through it during a first part of a switching cycle, during a last part of a switching cycle, or during a full part of a switching cycle. Herein, it is envisaged that the resistor 250 is always placed such that it is in series with the inductor 230 during at least a part of a full switching cycle/period of the switching element 240. Herein, a “full switching cycle/period” includes both a closing and an opening of the switching element 240, such that the inductor 230 has time to both receive energy and release energy (but not necessarily in that particular order). If the current sensing resistor 250 is placed at or towards a positive supply-rail, one may talk about high-side current sensing. Likewise, if the current sensing resistor 250 is placed at or towards a negative supply-rail (or ground) of the converter 200, one may instead talk about low-side current sensing.

Using a Buck-converter as an example, the resistor 250 may be located between the input terminal 220 and the switching element 240 to measure a peak-current of the inductor 250. The resistor 250 can also instead be located directly adjacent to the inductor 230, such that it measures an average current through the inductor 230. Other alternatives are of course also possible, applying also to the other known types of converters such as Boost, Buck-boost/Flyback, and other, converters. The control logic module 210 may also use other parameters in order to control the switching, including e.g. measurements of an input voltage and/or an output voltage of the converter 200, and similar. The converter may thus include one or more feedback loops in addition to the feedback loop including sensing the current is to output the control signal to the switching element 240.

FIG. 2B schematically illustrates the converter 200 with a voltage source 260 (such as a DC output from a generator) connected to the input terminals 220, and with an energy storage element 262 connected to the output terminals 221, thus forming an energy harvesting system as discussed earlier herein. The energy storage element 262 is here in the form of a capacitor, but may of course also be e.g. a battery, supercapacitor or similar. The voltage source 260 provides an input voltage ν₁ at the input terminal 220, and the converter 200 provides a resulting output voltage ν₂ at the output terminal 221 (and across the energy storage element 262). Although the various voltages are illustrated as having a particular polarity, it should be noted that this is for illustrative purposes only, and that the voltage polarities may be different depending on the exact type of converter and overall setup used.

A typical control algorithm of the converter 200 includes first charging the inductor 230 during a first time period (the end of which occurs when the voltage vs is determined to exceed a threshold value, corresponding to a maximally allowed current through the inductor 230), and to then discharge the inductor 230 during a second time period following the first time period (wherein the second time period ends once the measured voltage vs once again goes below the threshold value). The charging of the inductor is initiated by controlling the switching element 240 to a state in which current may flow between the input terminal 220 of the converter 200 and the inductor 230, and the discharging of the inductor 230 is initiated by controlling the switching element 240 to another state wherein current may flow between the inductor 230 and the output terminal 221 of the converter 200. To avoid changing the state of the switching element 240 too frequently, hysteresis is often added, e.g. by splitting the single threshold value into upper and lower threshold values.

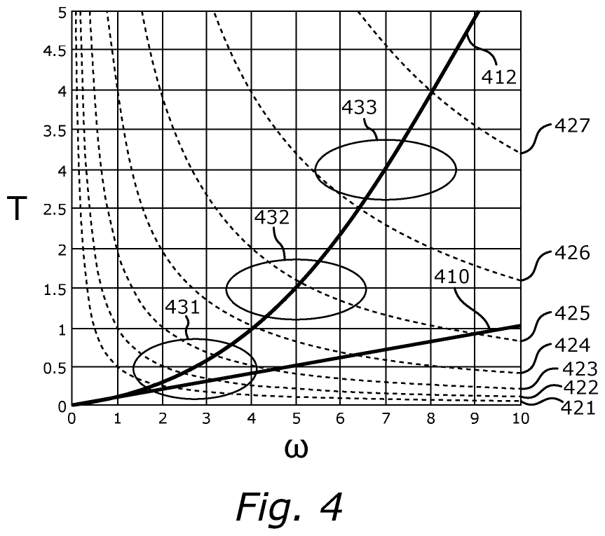

With reference to FIG. 4, drawbacks of a traditional converter as described above will now be elaborated on in more detail. FIG. 4 schematically illustrates a plot of the amount of torque (T) needed to make a generator connected to a converter spin at a certain rotational speed (w). If seen the other way around, FIG. 4 also illustrates the amount of speed w that a user spinning the generator would need to achieve in order to be able to apply a certain amount of torque T to the generator. FIG. 4 also shows a plurality of dashed lines 421-427, each indicating a constant output power of the generator. Using arbitrary units, the line 421 may for example correspond to an output power P₁=0.5, the line 422 to an output power P₂=1, the line 423 to an output power P₃=2, the line 424 to an output power P₄=4, the line 425 to an output power P₅=8, the line 426 to an output power P₆=16, and the line 427 to an output power P₇=32.

For a traditional generator and converter combination, the input impedance of the converter is such that there is a linear relationship between torque T and rotational speed w (i.e., the loading of the generator by the converter is constant). An example of such a constant load-line is illustrated by the curve 410. For the sake of argument, it can be assumed herein that a weaker user can only supply a maximum torque around T=0.5, that an intermediate user can supply a maximum torque around T=1.5, and that a stronger user can supply a maximum torque around T=4. As can be seen in FIG. 4, maximizing the output power for the generator (i.e. the power delivered by the generator to the converter) would require the weaker user to spin the generator at a speed ω=5, with a resulting output power of the generator then being a bit higher than P₃ but well below P₄. For the intermediate and stronger users, however, the optimal speeds would be much higher and even outside the interval of w illustrated in FIG. 4. Using extrapolation, the intermediate user would e.g. need to obtain a speed closer to ω=14 to maximize the output power of the generator (to somewhere around P₆), while the stronger user would require a speed as high as ω≈29. Phrased differently, a traditional converter and generator combination providing the constant load-line 410 would be more suited for weaker users, while intermediate and stronger users would not be able to fully make use of their abilities to provide higher torques, as the generator would then need to be turned very fast in order to obtain the maximal output power for the generator. The intermediate and stronger users would instead most likely feel that e.g. the doorknob connected to the generator feels too easy to turn, and their user experiences would be less than optimal. As they do not achieve the maximum possible output power of the generator, the time needed to sufficiently e.g. charge a battery of the energy harvesting system would be longer than optimal.

As a potential solution to the above problem, the use of a traditional generator and converter combination resulting in higher (but still constant) loading of the generator by the converter, and a resulting load-line steeper than the load-line 410, would be more suitable for e.g. the intermediate user. However, improving the user experience for the intermediate user in such a way would at the same time make the user experience for the weaker user worse, as the weaker user would now struggle to turn the generator as before (still being limited to a maximum applicable torque of T=0.5), and the resulting output power for the weaker user would instead be reduced to around P₂ or even P₁. Likewise, increasing the steepness of the load-line 410 even further, to improve the user experience of the stronger user, would make the user experience for the intermediate user worse, and most likely make it impossible for the weaker user to operate the doorknob at all.

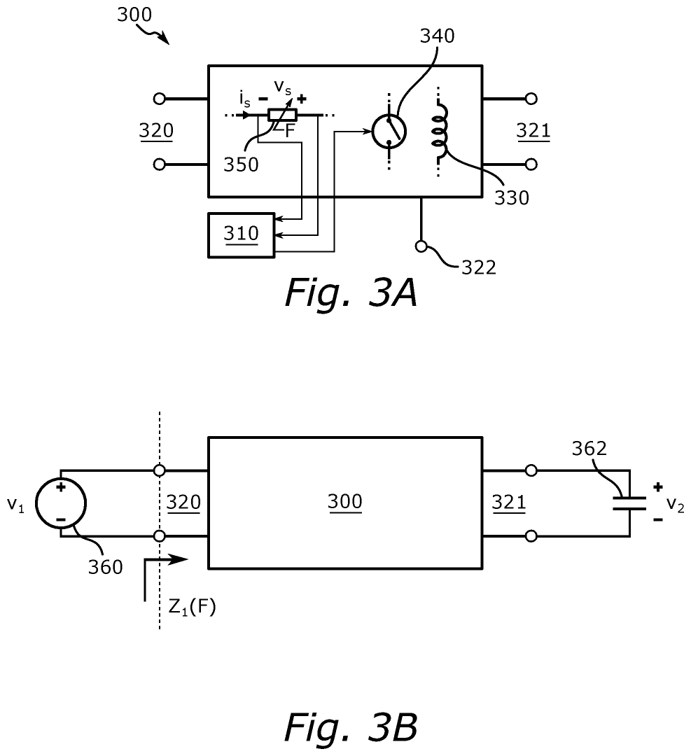

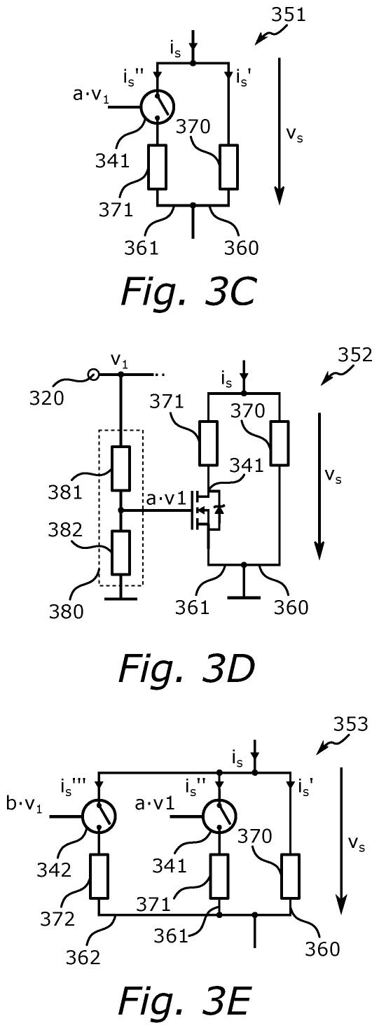

The present disclosure solves the above-mentioned issues by first realizing that the rotational speed (ω, rpm) of the generator will be proportional to the applied torque, and further that the output voltage of the generator (and thus the input voltage ν₁ to the converter) will be proportional to the rotational speed ω of the generator (as the EMF generated by the generator is proportional to its rotational speed ω). Consequently, the output voltage of the generator, and thus also the input voltage ν₁ to the converter, will be proportional to (a magnitude of) the actuation force applied to the generator by the user trying to open the door by e.g. turning a doorknob. By making the input impedance of the converter adaptable to the input voltage of the converter, such that the input impedance decreases with increasing input voltage of the converter, and vice versa, the range of user strengths resulting in a good user experience can be extended, as will be elaborated on further below. An improved converter as envisaged by the present disclosure will now be described with reference to FIGS. 3A-3E.

FIG. 3A schematically illustrates an example embodiment of an improved converter 300 according to the present disclosure, while FIG. 3B schematically illustrates e.g. the same converter 300 but with a voltage source 360 (representing the output voltage from a generator) connected at its input terminal(s) 320, and with an energy storage element (here in form of a capacitor) 362 connected at its output terminal(s) 321 (thereby forming the envisaged improved energy harvesting system). The converter 300 may or may not include a dedicated ground terminal 322. The converter 300 is similar to e.g. the converter 200 described with reference to FIGS. 2A and 2B, and includes the switching element 340 and the inductor 330 for the same purposes. However, a major difference between the converter 200 and the converter 300 according to the present disclosure is that the input impedance Z₁ of the converter 300 is made to depend on (a magnitude of) the actuation force F applied to the generator by the user, i.e. such that Z₁=Z₁(F). As will be described below, this can be achieved by making the input impedance Z₁(F) depend on the input voltage ν₁ to the converter, such that the input impedance Z₁(F) decreases when the input voltage ν₁ increases, and vice versa.

As envisaged herein, making the input impedance Z₁(F) depend on the actuation force F can for example be achieved by replacing the current sensing resistor 250 of the traditional converter 200 with a resistor circuit 350 whose resistance can dynamically be adjusted depending on the actuation force F. In FIG. 3A, this is illustrated by the little arrow on top of the resistor circuit 350. In particular, the resistor circuit 350 can be configured such that its resistance decreases when the actuation force F increases, and such that its resistance increases when the actuation force F decreases.

As the voltage vs across the resistor circuit 350 is (according to Ohm's law) proportional to the current is passing through the resistor circuit 350, adjusting the value of the resistance of the resistor circuit 350 will influence the outcome of the control method (as implemented by the control logic module 310) detecting the current is by measuring the voltage vs. By decreasing the resistance of the resistor circuit 350 when F increases, the control method will allow the current is to rise higher before deciding that the current is is high enough to initiate an opening of the switching element 350, as the voltage vs will reach the corresponding voltage threshold value used for such opening of the switching element 350 later. This will have the effect that the average current through the inductor 330 will be increased, applying possibly also the peak and valley currents through the inductor 330 during the switching cycle. Consequently, the input impedance Z₁(F) of the converter 300 will decrease as the actuation force F increases, and thereby increase the loading of the generator as more current will (at least on average) flow into the input terminal(s) 320 of the converter 300. This adaptive loading of the generator by the converter results in a non-linear relationship between torque T and rotational speed ω for the improved generator and converter 300 combination (and the improved energy harvesting system), as will be described further below by referring back to FIG. 4 again.

To further illustrate the envisaged principle of changing the input resistance depending on the actuation force provided by the user, one may consider any inductor-based DC/DC converter which relies on some form of inductor-current control with a maximum and a minimum value. These current-limits may have different values depending on in which load (charging/discharging) and load conditions the converter is currently operating in.

For example, the inductor-current can be assumed to be increasing while the inductor is connected to the input of the converter (i.e. during the charging state of the converter), and decreasing while the inductor is connected to the output of the converter (i.e. during the discharging state of the converter). The exact duty-cycle may vary depending on the actual working-conditions of the converter. The input (load) impedance may be assumed as the average of the input voltage divided by the average input current to the converter. In most cases, the input current is however (essentially) zero during the discharging state of the converter. The average input current is thus (assuming a 50% duty-cycle) half of the average current through the inductor, where the average current through the inductor is given as the minimum inductor current plus half the difference between the maximum and minimum inductor current. The present disclosure proposes to change the average inductor current by adaptively changing the resistance of the current sensing resistor as a function of the magnitude of the actuation force. As the resistance of the current sensing resistor affects the respective maximum and minimum currents through the inductor, changing the value of the current sensing resistance thereby changes the average inductor current. A standard DC/DC converter often have negative differential input impedance, such that an increase in input voltage results in a decrease in input current, and vice versa. With the solution as provided herein, the input current is instead made dependent on the input voltage (i.e. dependent on the magnitude of the actuation force), and hence allow to emulate a progressive load of the input of the converter. The solution as envisaged herein is applicable for all DC/DC converters which rely on an external current sensing resistor, and for which it is possible to operate in a current-limiting mode when the output voltage of the converter is less than the normal set-voltage of the converter. The exact implementation does of course depend on the type of converter used, but still follows the general principle disclosed herein.

In FIG. 4, an example of such an adaptive load-line is represented by the curve 412. As the input impedance Z₁(F) of the converter 300 decreases as the actuation force (and thereby the torque) applied by the user to the generator increases, this will make the generator harder to turn (c.f. a generator being hardest to turn when its output terminals are short-circuited, corresponding to a zero input impedance of the converter). The corresponding load-line 412 will therefore not be straight, as it will increasingly harder and harder to turn the generator with increasing torque levels. For the weaker user, the user experience would be approximately the same as for the traditional generator and converter 200 combination, as the two curves 410 and 412 do not deviate much from each other in the region 431 where the weaker user is most likely to operate. Still having a maximum applicable torque of T=0.5, the weaker user would now have to spin the generator at a slightly lower speed ω=3, and would then obtain a slightly reduced generator output power a bit less than P₃. For the intermediate user, however, the required speed at T=1.5 is now reduced to around ω=5, and the resulting output power of the generator is around P₅. The intermediate user can now utilize its full potential in terms of applicable torque, and charge e.g. the battery of the energy harvesting system more quickly than if using the traditional generator and converter combination (as the required speed of ω=5 is more reasonable and the user experience thereby improved). The stronger user would also be able to use its full potential at T=4, as the required speed is a tolerable ω=7 instead of the excessive (and most likely impossible to achieve) ω≈29 required when using the traditional, constant load-line 410. The resulting, optimal output power of the generator obtained is above P₆, and the stronger user would thus be able to charge the battery of the energy harvesting system even quicker, while still having a sufficiently good user experience as no excessive speeds w are involved.

Phrased differently, the improved converter 300 (and energy harvesting system) as envisaged herein allows to provide a user-experience which is good for users of different strength levels, while keeping the rotational speeds w of the generator needed to optimize generator output power within tolerable ranges. For the improved converter 300 (and energy harvesting system), weaker users (see region 431), intermediate users (see region 432) and stronger users (see region 433) would all be able to turn the generator at around ω=3−7 while still optimizing generator output power. The weaker user would have to work a bit longer in order to sufficiently charge e.g. a battery, but without having to provide any torque above its capability. Similarly, intermediate and stronger users would be able to charge the battery more quickly as they would be able to apply higher torques. This in contrast to the traditional generator and converter combination resulting in the constant load-line 410, wherein the speeds (ω=14 and ω≈29) required for intermediate and stronger users to make use of their full torque input capability would not be realistic to achieve, and the user-experiences of these users would be less than optimal as their full torque input capability would not be used when charging the batteries, resulting in longer-than-optimal charging times.

The (magnitude of the) actuation force F is proportionally related to the output voltage of the generator (assembly). Consequently, the output voltage of the generator (assembly), and consequently also the input voltage ν₁ to the converter 300, can thus be considered to represent the actuation force F. FIG. 3C schematically illustrates an example embodiment of a resistor circuit 351 as envisaged herein, which uses the above fact to adapt its resistance as desired. The resistor circuit 351 includes a first branch 360 and a second branch 361. The first branch 360 and the second branch 361 are connected in parallel. The first branch 360 includes a first resistor 370, and the second branch 361 includes a second resistor 371 and a switching element 341 connected in series. The switching element 341 is preferably e.g. a MOSFET, or any other type of e.g. voltage-controlled switching element wherein a current between its drain- and source-terminals can be regulated based on a voltage applied at its gate-terminal. The switching element 341 is controlled by a signal proportional to the input voltage ν₁ (i.e. proportional to the output voltage of the generator and the actuation force F), i.e. based on a*ν₁, where a is a proportionality constant which can be configured as desired.

The functioning of the resistor circuit 351 can be described as follows. When little actuation force F is provided to the generator by the user, the voltage ν₁ will be low and the switching element 341 will either be open or allowing little current to pass through the second branch 361. Thus, the first resistor 370 will correspond to all or almost all of the resistance of the resistor circuit 351 as used to generate the voltage vs from the current is. This because as the switching element 341 is open or almost open, all or most of the current is will be routed as the current is' through the first branch 360. On the other hand, if the applied actuation force is high, the voltage 11 will be high and the switching element 341 will be either fully or almost fully closed and allow more current to pass through the second branch 361. Consequently, the proportion of current iₛ″ passing through the second branch 361 will increase, and the overall resistance of the resistor circuit 351 will thus decrease as there are now two available branches 360 and 361 for the current is to be routed through. In particular, independent of the exact values of the resistors 370 and 371, both of them connected in parallel will always provide a lower overall resistance than the first resistor 370 only. If the second resistor 371 is selected to be smaller or much smaller than the first resistor 370, the second resistor 371 will determine most of the overall resistance of the resistor circuit 351 when the input voltage ν₁ is high. Also importantly, the transition between the overall resistance being governed mostly by the first resistor 370 to the overall resistance being governed mostly by the second resistor 371 can be made smooth, e.g. by operating the switching element 341 in a region wherein its source-drain current gradually increases as 11 increases, leading to an improved user experience as there will then be no sudden changes to the experienced turning resistance of the generator.

FIG. 3D schematically illustrates an example embodiment of a resistor circuit 352 as envisaged herein, wherein a voltage-divider circuit 380 is included to provide the voltage proportional to ν₁, and wherein the switching element is implemented using an N-channel MOSFET. The input voltage ν₁ is applied across the voltage divider circuit 380, and the gate-voltage to the MOSFET 341 is given as a*ν₁, where a=R₂/(R₁+R₂) where R₁ is a resistance of the resistor 382, and R₂ is a resistance of the resistor 381. Consequently, the use of the voltage divider circuit 380 allows the proportionality constant a to be tuned by changing the values of the resistors 381 and 382. As mentioned earlier herein, the polarities of the various voltages are not necessarily as illustrated in the figures. For example, it may be envisaged that the voltage ν₁ is lower than e.g. a ground (such that e.g. the voltage at the other end of the voltage divider circuit 380 is higher than ν₁, and or e.g. that the voltage vs is negative. In such a situation, a similar functionality may be achieved by e.g. replacing the N-channel MOSFET 341 with a P-channel MOSFET instead.

In common to the resistor circuits 351 and 352 is that they provide a smooth transition between a situation wherein only a single branch 360 is conducting, and a situation in which both branches 360 and 361 are conducting, or even a situation wherein mostly the other branch 361 is conducting. As already mentioned above, the user experience will thus be smooth as the user will not feel any sharp transition between these states. If the actuation force is increased, the resistance of the resistor circuits 351 and 352 will smoothly decrease, and if the actuation force is decreased the same resistance will instead smoothly increase.

FIG. 3E schematically illustrates another embodiment of a resistor circuit 353. The resistor circuit 353 is similar to the resistor circuit 351, but includes an additional third branch 362. The third branch 362 is connected in parallel with the first branch 360 and the second branch 361, and includes a third resistor 372 and a second switching element 342 connected in series. The second switching element 342 is also controlled based on a value proportional to the input voltage ν₁, but it is here envisaged that the proportionality constant (i.e. “b”) can be different from that used to control the second switching element 341 in the second branch 361 such that the two branches 361 and 362 are not inserted/added simultaneously. Instead, it may be envisaged e.g. that the third branch 362 is inserted gradually later than the second branch 361 (with increasing input voltage ν₁), thus forming a three-step load-line (with a still smooth transition between the various steps) in contrast to the two-step load-line provided e.g. by the resistor circuits 351 and 352. It is of course envisaged that also additional (such as a fourth, fifth, etc.) branches can be added, each including a resistor and switching element in series, and that the proportionality constants can be adapted such that these additional branches provide additional steps to the load-line, making the user-experience even more smooth.

Although not illustrated specifically herein, it is envisaged also that e.g. the voltage divider circuit 380 of FIG. 3D can be replaced by e.g. a microcontroller which is able to measure the input voltage ν₁, and which is able to (using e.g. a digital-to-analog converter, DAC) output a voltage proportional to the input voltage 11 to control the switching element 341. It is also envisaged that instead of a resistor circuit as illustrated in any of FIGS. 3C-3E, a digital potentiometer may be used, preferably in combination with a microcontroller, to provide a resistance which can be used to sense the current is, and which can be changed dynamically based on e.g. the input voltage ν₁. In other envisaged embodiments, it may be envisaged that the (magnitude of the) actuation force F and the resulting torque T can be detected using other means than by the output voltage of the generator, and instead be provided by e.g. using one or more torque sensors (or similar) mounted to the generator. In general, the present disclosure envisages all solutions resulting in there being a resistance used to sense the current is as part of a control method for switching the inductor of the converter, and wherein this resistance can be dynamically changed based on the (magnitude of the) actuation force F such that the resistance decreases when F increase, and vice versa. By so doing, the input impedance of the converter (assembly) can be adapted to the (magnitude of the) actuation force as described herein, such that the input impedance decreases with increasing actuation force and vice versa.

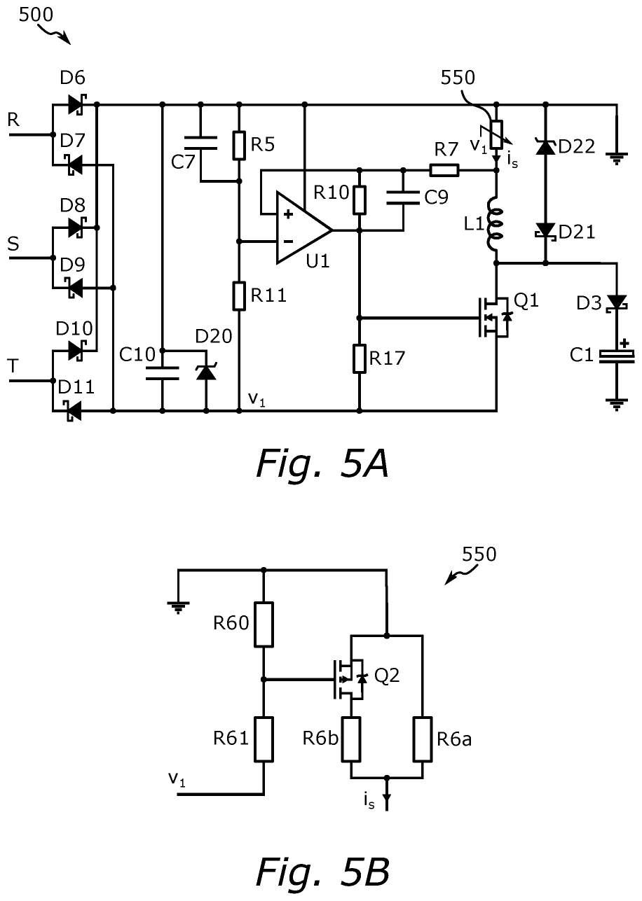

FIG. 5A schematically illustrates an embodiment of a converter 500 as envisaged herein, wherein the converter 500 is based on the converter previously disclosed by the applicant in international patent application PCT/EP2017/083884. The converter 500 does however differ from that previous disclosed in that the converter 500 uses a resistor circuit 550 as envisaged herein to measure the current iₛ through the inductor L1, instead of only a single current sensing resistor having a constant resistance.

The converter 500 is an assembly configured to receive AC power (from e.g. a generator such as discussed herein). The AC power arrives at three phases R, S and T, and is converted to DC power using the rectifying diode-bridge formed by the diodes D6-D11. This rectifying arrangement may or may not form part of the converter assembly itself. Optional input over-voltage protection is provided by the diode D20. The converter 500 operates by comparing a voltage across the resistor circuit 550 to a voltage proportional to an input (DC) voltage ν₁ using a comparator U1. The voltage proportional to the input voltage ν₁ is obtained using a voltage divider circuit formed by the resistors R5 and R11, and provided at the negative input of the comparator U1. The comparator is optionally provided with hysteresis, configured by the resistors R7 and R10, and the capacitor C9 (wherein the hysteresis current is set by R7/R10). The switching element is a (N-channel) MOSFET Q1 whose gate is connected to the output of the comparator U1. Output over-voltage protection is optionally provided by the diodes D21 and D22. A supercapacitor C1 serves as the energy storage element and is connected to the output of the converter 500 via a diode D3. The converter 500 also includes additional components such as the capacitors C7 and C10, as well as the resistor R17 connected between the gate of the switching element Q1 and the rail where the input voltage ν₁ is present. If replacing the resistor circuit 550 with a fixed resistance (as is the case in the circuit as previously disclosed by the applicant in the above referred-to international patent application), the (average) inductor-current through L1 is set by R5/R11 and this fixed resistance. If the input voltage ν₁ is relatively small, the (average) inductor-current would thus be proportional to ν₁, which would provide a more or less constant input impedance of the circuit 500. However, as envisaged herein, the resistor circuit 500 does not have constant resistance, but instead a resistance which adapts dynamically to the magnitude of the input voltage ν₁. As described herein, this provides the desired effect of providing an input impedance of the circuit 500 which adapts to the input voltage ν₁ and thereby to the (magnitude of the) actuation force applied by the user.

The particular design of the converter 500 as shown in FIG. 5A only serves for the purpose of enablement, and provides an example of a converter in which the resistor circuit 550 can be used to achieve the advantages described herein. As stated throughout this description, the adaptive sensing resistance can be implemented and used also in other types of converters, and the particular design of the converter 500 does thus not limit the scope of the disclosure or the claims.

FIG. 5B schematically illustrates an embodiment of a specific configuration of the resistor circuit 550 included in the converter 500, also for purposes of enablement. As described earlier herein, the resistor circuit 550 includes two branches in parallel, wherein one branch includes the resistor R6a, and the other branch includes the resistor R6b and the switching element (MOSFET) Q2 connected in series. The gate of the switching element Q2 is controlled by a voltage which is proportional to the voltage ν₁, by use of a voltage divider formed by the resistors R60 and R61. In the converter 500, it is assumed that the voltage ν₁ is negative (i.e. lower than the ground potential), and the MOSFET Q1 is therefore an N-channel MOSFET. If the voltage ν₁ was instead positive, the MOSFET Q1 could be replaced with e.g. a P-channel MOSFET instead. The functioning of the resistor circuit 550 is however as described earlier, wherein more and more current is allowed to pass through the second branch as the magnitude of the voltage ν₁ increases.

For the above example of the converter 500, the parameters of the various components may for example be selected as follows. The diodes D6-D11 and D22 may for example be of a type CUS08F30. The diode D10 may for example be of a type BZT585B6V8T-7. The diode D21 may for example be of a type BZX384-B4V7. The diode D3 may for example be of a type allowing 60 volts and a current of 3 amperes. The comparator U1 may for example be of a type NCS2001SN2T1. The switching element Q1 may for example be of a type Si2318DS. The inductor L1 may for example have an inductance of 330 uH. The resistors may for example be such that R5 is 2 kΩ, R7 is 3.3 kΩ, R10 is 10 MΩ, R11 is 100 kΩ, and R17 is 1 MΩ. The capacitors may for example be such that C7 is 0.1 uF, C9 is 47 pF, C10 is 10 uF, and the supercapacitor C1 may be e.g. 1F and rated for 5.0 volts, such as for example of a type EECHLOE255. For the resistor circuit 550, the components may e.g. be such that R60 is 100 kΩ, R61 is 180 kΩ, R6a is 6.2 Ω, and R6b is 0.62 Ω. The switching element Q2 may for example be of a type NX2301P. It should be noted that all of these component types and values are provided for enablement purposes only, and that they in no way limit the scope of the invention and the appended claims. It is envisaged that the type of components and/or their values may be changed as desired, depending on a desired characteristic of the converter 500 as a whole. Likewise, some components may be added, and/or some components may be removed. As long as the desired effect due to the adaptive resistor circuit 550 and its dependence on ν₁ is preserved (i.e. the change of the converters input impedance in a direction opposite to that of the input voltage and the size of the actuation force), the configuration of the converter 500 and any other embodiments of converters presented herein may be changed as desired. For example, the output current of the converter 500 will vary between a minimum and maximum current value, independent of the output voltage when the output is connected to the inductor L1. When the inductor Li is instead connected to the input, the output current will be zero. Here, we assume that overvoltage-protection and similar are not involved, and that the converter is operated within its normal boundaries. The input impedance of the converter 500 is thus equal to (average) input voltage divided by average input current, where the average input current is in turn equal to duty cycle times average inductor current, where duty-cycle may be defined as charging-time divided by switching-time. The average inductor current is in turn proportional to one over the resistance of the current sensing resistor circuit 550, which gives that input impedance of the converter 500 is proportional to the resistance of the current sensing resistor circuit 550. As this resistance is increased (as shown in e.g. FIG. 5B) when the magnitude of the input voltage (and actuation force) decreases, and vice versa, we thus obtain the desired functionality where the input impedance of the converter 500 decreases when the actuation force increases, and vice versa, resulting in the improved user-experience discussed herein.

In summary of all embodiments disclosed herein, by making the input impedance of the converter adaptive to the actuation force provided by the user, the perceived user experience can be made more convenient for a broader range of user strengths. At the same time, energy harvesting can be made more efficient such that, for each user, the energy storage element can be charged as quickly as possible without degrading the user experience. The envisaged functionality can be implemented in basically any switched-mode (inductor-based) DC/DC converter originally using an external current sensing resistor as part of its control method. Without other changes to such circuit, replacing the traditional current sensing resistor with an adaptive resistive circuit as envisaged herein will change the average current level (and possibly also the peak and valley current levels) in the inductor proportionally, resulting in an adaptive input impedance of the converter which decreases with increasing actuation force, and vice versa.

It is also envisaged that e.g. a converter as disclosed herein can be useful also in other situations not including a generator. For example, if using the converter to power e.g. an LED from a battery, a higher battery voltage will result in a higher current to the LED and thereby more emitted light, while a lower battery voltage will result in a lower current to the LED and less light. By adapting the light output to the voltage level of the battery, the LED can be made to emit more light when the battery is new, and emit less light when the battery becomes older, and thereby extend the life of the battery in this situation.

Although features and elements may be described above in particular combinations, each feature or element may be used alone without the other features and elements or in various combinations with or without other features and elements.

Additionally, variations to the disclosed embodiments may be understood and effected by the skilled person in practicing the claimed invention, from a study of the drawings, the disclosure, and the appended claims. In the claims, the words “comprising” and “including” does not exclude other elements, and the indefinite article “a” or “an” does not exclude a plurality. The mere fact that certain features are recited in mutually different dependent claims does not indicate that a combination of these features cannot be used to advantage.

1. An energy harvesting system comprising:
an energy storage element;
a generator assembly configured to convert an actuation force provided by a user into an electrical power; and
a power converter assembly configured to transfer the electrical power from the generator assembly to the energy storage element;
wherein the power converter assembly is further configured to adapt an input impedance of the power converter assembly to a magnitude of the actuation force by decreasing the input impedance when the magnitude of the actuation force increases, and by increasing the input impedance when the magnitude of the actuation force decreases.

2. The energy harvesting system according to claim 1, wherein;
the power converter assembly is of a switched-mode type and includes an inductor switched to alternately i) store energy received from the generator assembly during a first part of a full switching period and ii) release stored energy to the energy storage element during a second part of the full switching period;
the input impedance of the power converter assembly depends on a switching of the inductor performed based on a first voltage across a resistor circuit which is connected in series with the inductor during at least one of the first and second parts of the full switching period; and
the resistor circuit is configured to help cause the adaptation of the input impedance of the power converter assembly to the magnitude of the actuation force by decreasing a resistance of the resistor circuit when the magnitude of the actuation force increases and by increasing the resistance when the magnitude of the actuation force decreases.

3. The energy harvesting system according to claim 2, wherein the magnitude of the actuation force is provided as a second voltage proportional to an output voltage of the generator assembly.

4. The energy harvesting system according to claim 3, further comprising a voltage divider circuit for providing the second voltage proportional to the output voltage of the generator assembly.

5. The energy harvesting system according to claim 3, further comprising a first microprocessor-based circuit configured to obtain the output voltage of the generator assembly and to provide the second voltage proportional to the output voltage of the generator assembly.

6. The energy harvesting system according to claim 3, wherein the resistor circuit includes a first branch and a second branch connected in parallel, wherein the first branch includes a first resistor, wherein the second branch includes a second resistor and a switching element connected in series, and wherein the switching element is configured to be controlled based on the second voltage.

7. The energy harvesting system according to claim 6, wherein the resistor circuit further includes a third branch connected in parallel with the first and second branches, wherein the third branch includes a third resistor and a second switching element connected in series, and wherein the second switching element is configured to be controlled based on a third voltage proportional to the output voltage of the generator assembly.

8. The energy harvesting system according to claim 2, wherein the resistor circuit includes a digital potentiometer and a microprocessor-based circuit, wherein the microprocessor-based circuit is configured to obtain the magnitude of the actuation force and based thereon control resistance of the resistor circuit using the digital potentiometer.

9. A power converter assembly comprising:
an input terminal for receiving an input voltage; and
an output terminal for providing an output voltage;
wherein the power converter assembly is configured to transfer an electrical power from the input terminal to the output terminal; and
wherein the power converter assembly is further configured to adapt an input impedance of the power converter assembly to the input voltage at the input terminal by decreasing the input impedance when a magnitude of the input voltage increases, and by increasing the input impedance when the magnitude of the input voltage decreases.

10. The power converter assembly according to claim 9, wherein the power converter assembly is of a switched-mode type and includes:
an inductor;
a switching element for switching the inductor to alternately i) store energy received at the input terminal during a first part of a full switching period and ii) release stored energy at the output terminal during a second part of the full switching period; and
a resistor circuit connected in series with the inductor during at least one of the first and second parts of the full switching period;
wherein the switching of the inductor is performed based on a first voltage across the resistor circuit; and
wherein the resistor circuit is further configured to decrease its a resistance of the resistor circuit when a magnitude of the input voltage increases and to increase its the resistance when the magnitude of the input voltage decreases.

11. The power converter assembly according to claim 10, wherein the resistor circuit includes a first branch and a second branch connected in parallel, wherein the first branch includes a first resistor, wherein the second branch includes a second resistor and a switching element connected in series, and wherein the switching element is configured to be controlled based a second voltage proportional to the input voltage.

12. The power converter assembly according to claim 11, wherein the resistor circuit further includes a third branch connected in parallel with the first and second branches, wherein the third branch includes a third resistor and a second switching element connected in series, and wherein the second switching element is configured to be controlled based on a third voltage proportional to the input voltage.

13. The power converter assembly according to claim 11, including a voltage divider circuit for providing the second voltage proportional to the input voltage.

14. The power converter assembly according to claim 10, wherein the resistor circuit includes a digital potentiometer and a microprocessor-based circuit, wherein the microprocessor-based circuit is configured to obtain the input voltage and based thereon control the resistance of the resistor circuit using the digital potentiometer.

15. An electronic lock comprising a handling element, an electronic lock controller, and an energy harvesting system;
wherein the energy harvesting system comprises:
an energy storage element;
a generator assembly configured to convert an actuation force provided by a user into an electrical power; and
a power converter assembly configured to transfer the electrical power from the generator assembly to the energy storage element;
wherein the power converter assembly is further configured to adapt an input impedance of the power converter assembly to a magnitude of the actuation force by decreasing the input impedance when the magnitude of the actuation force increases, and by increasing the input impedance when the magnitude of the actuation force decreases; and
wherein the handling element is mechanically connected to the generator assembly such that the actuation force results from a force applied to the handling element by the user, and wherein the energy storage element of the energy harvesting system is configured to power the electronic lock controller.
